(19) United States
(12) Patent Application Publication
(10) Pub. No.: US 2018/0298765 A1
(43) Pub. Date: Oct. 18, 2018

(54) ENGINE COMPONENT WITH REPLACEABLE TIP ELEMENT

(71) Applicant: General Electric Company, Schenectady, NY (US)

(72) Inventors: Matthew Thomas Beyer, West Chester, OH (US); Gregory Terrence Garay, West Chester, OH (US); Kirk D. Gallier, Cincinnati, OH (US); Toby George Darkins, JR., Loveland, OH (US)

(21) Appl. No.: 15/487,981

(22) Filed: Apr. 14, 2017

(51) Int. Cl. F01D 5/20; F01D 5/28; F01D 5/30

(52) U.S. Cl. CPC F01D 5/20; F01D 5/284; F05D 2230/80; F05D 2300/6033; F01D 5/3007

(57) ABSTRACT

An apparatus and method for a replaceable tip element of an airfoil in a turbine engine. The airfoil has an outer wall defining an interior and including a pressure side and a suction side extending axially between a leading edge and a trailing edge defining a chord-wise direction and extending radially between a root and a tip defining a span-wise direction, with the tip having a replaceable tip element.

### BACKGROUND OF THE INVENTION

Turbine engines, and particularly gas or combustion turbine engines, are rotary engines that extract energy from a flow of combusted gases passing through the engine onto a multitude of rotating turbine blades.

The construction and fabrication of airfoils for use in gas turbine engines for aircraft typically utilizes super alloys. Due to extremely harsh environments in which the airfoils typically operate, the super alloys work well because of their strength components in extremely high temperature environments. The super alloys, however, can be relatively expensive and add higher weight to the engine.

### BRIEF DESCRIPTION OF THE INVENTION

In one aspect, the present disclosure relates to an airfoil for a turbine engine, the airfoil comprising an outer wall defining an interior and including a pressure side and a suction side extending axially between a leading edge and a trailing edge defining a chord-wise direction and extending radially between a root and a tip defining a span-wise direction, with the tip having a replaceable tip element.

In another aspect, the present disclosure relates to an engine component for a turbine engine, the engine component comprising an outer wall defining an interior and including a pressure side and a suction side extending axially between a leading edge and a trailing edge defining a chord-wise direction and extending radially between a root and a tip defining a span-wise direction, with the tip having a replaceable tip element.

In another aspect, the present disclosure relates to a method of manufacturing an airfoil extending between a leading edge and a trailing edge to define a chord-wise direction and extending between a root and a tip to define a span-wise direction, the method comprising molding a metal base portion with a tip element having a non-metal portion.

In yet another aspect, the present disclosure relates to a method of manufacturing an airfoil extending between a leading edge and a trailing edge to define a chord-wise direction and extending between a root and a tip to define a span-wise direction, the method comprising molding a base portion with an open tip, and enclosing the open tip with a replaceable composite tip element.

### BRIEF DESCRIPTION OF THE DRAWINGS

In the drawings:

FIG. 1 is a schematic cross-sectional diagram of a turbine engine for an aircraft.

FIG. 2 is a perspective view of an airfoil of the turbine engine of FIG. 1 according to aspects of the disclosure described herein.

FIG. 3 is a section view of the tip of FIG. 2 with a replaceable tip element including a dovetail mechanically connected to a seat.

FIG. 4 is a side view of a tip of the airfoil of FIG. 2 with the replaceable tip element removed from the seat.

FIG. 5 is a top view of the seat of FIG. 4 with a curved groove for receiving the dovetail of FIG. 3.

FIG. 6 is a top view of another exemplary seat with holes for receiving the dovetail of FIG. 3.

FIG. 7A is a side view of the exemplary seat of FIG. 6 with the replaceable tip element in a first position.

FIG. 7B is a side view of the exemplary seat of FIG. 6 with the replaceable tip element in a second position.

FIG. 7C is cross-section of the replaceable tip element of FIG. 7B in the second position.

FIG. 7D is a side view of the exemplary seat of FIG. 6 with the replaceable tip element in a second position and receiving locking material through an insert hole.

FIG. 8 is a section view of a second exemplary replaceable tip element including a dovetail mechanically connected to a seat.

FIG. 9 is a section view of a third exemplary replaceable tip element including a dovetail mechanically connected to a seat.

FIG. 10 is a section view of a fourth exemplary replaceable tip element including a T-rail mechanically connected to a seat.

FIG. 11 is a section view of a fifth exemplary replaceable tip element including a collar mechanically connected to a seat.

FIG. 12 is a section view of a sixth exemplary replaceable tip element welded to a seat including a brazen adhesive.

FIG. 13 is a section view of a seventh exemplary replaceable tip element welded to a seat and including a bridge within the replaceable tip element.

FIG. 14 is a section view of an eighth exemplary replaceable tip element welded to a seat and including cooling channels within the replaceable tip element.

### DESCRIPTION OF EMBODIMENTS OF THE INVENTION

The described embodiments of the present invention are directed to an engine component for a turbine engine. For purposes of illustration, the present invention will be described with respect to an airfoil for an aircraft gas turbine engine. It will be understood, however, that the invention is not so limited and may have general applicability within an engine, including compressors, as well as in non-aircraft applications, such as other mobile applications and non-mobile industrial, commercial, and residential applications. Additionally, the aspects will have applicability outside of an airfoil, and can extend to any engine component requiring cooling, such as a blade, vane, shroud, or a combustion liner in non-limiting examples.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

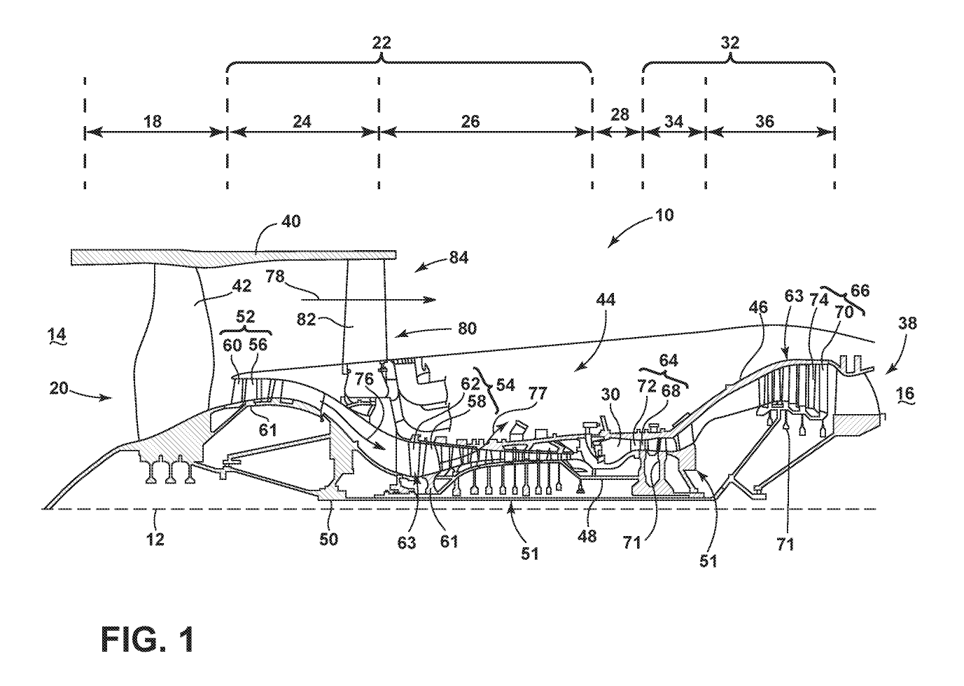

FIG. 1 is a schematic cross-sectional diagram of a turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized airflow 76 to the HP compressor 26, which further pressurizes the air. The pressurized airflow 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

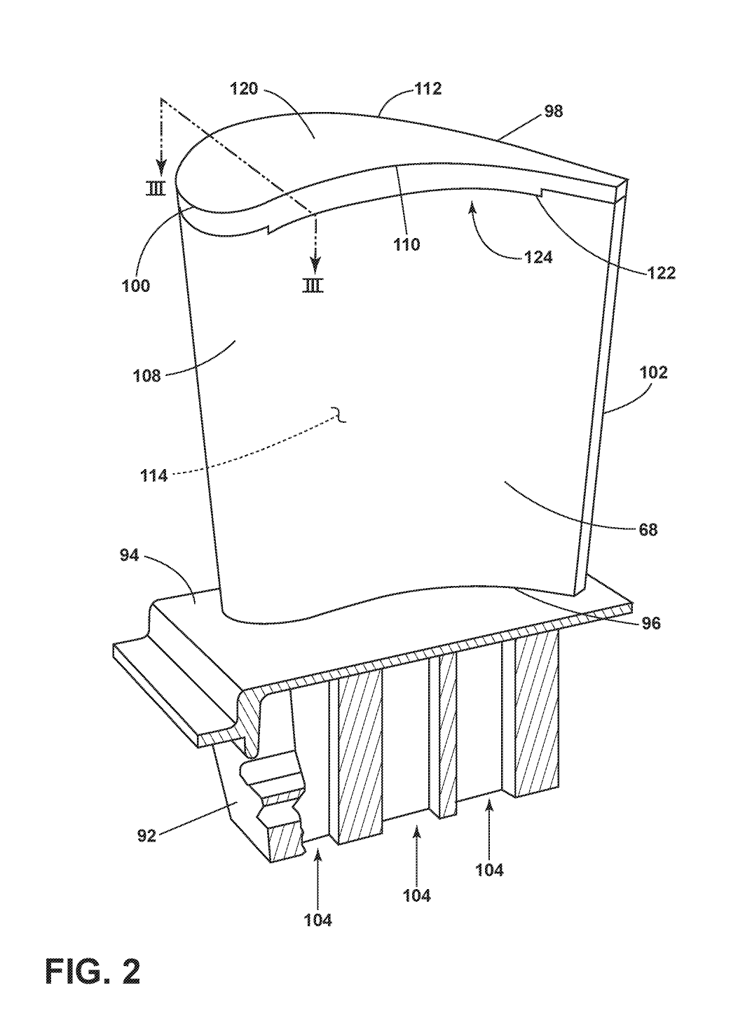

Referring now to FIG. 2, an exemplary engine component is shown in the form of an airfoil 90, which can be one of the turbine blades 68 of the engine 10 of FIG. 1 for example. Alternatively, the engine component can include any other rotating blade, stationary vanes, or any other engine component that can require or utilize cooling in a tip or thin edge area. The airfoil 90 includes a base, illustrated as a dovetail mount 92 and a platform 94. The airfoil 90 extends radially between a root 96 and a tip 98 defining a span-wise direction. The airfoil 90 extends axially between a leading edge 100 and a trailing edge 102 defining a chord-wise direction. The dovetail mount 92 can be integral with the platform 94, which can couple to the airfoil 90 at the root 96. The dovetail mount 92 can be configured to mount to a turbine rotor disk on the engine 10. The platform 94 helps to radially contain the turbine airflow. The dovetail mount 92 comprises at least one inlet passage 104, shown as three exemplary inlet passages 104, each extending through the dovetail mount 92 in fluid communication with the airfoil 90. It should be appreciated that the dovetail mount 92 is shown in cross-section, such that the inlet passages 104 are housed within the dovetail mount 92. It should further be appreciated that other bases are possible and do not necessarily need to include the dovetail structure.

The airfoil 90 includes an outer wall 108 having a pressure side 110 and a suction side 112 extending between the leading edge 100 and the trailing edge 102. An interior 114 of the airfoil 90 is defined by the outer wall 108. A replaceable tip element 120 defines at least a portion of the outer wall 108 at the tip 98. A seat 122 defines an upper area 124 of the blade 68 proximate the tip 98. The replaceable tip element 120 can be configured to mount to the seat 122 to enclose the interior 114 of the airfoil 90 at the tip 98.

It is contemplated that the replaceable tip element 120 can be mounted to the seat 122 in several different ways. For example, the replaceable tip element 120 can be co-cast to the seat 122 during manufacturing. It is also further contemplated that a mechanical coupling, such as a slide and lock mechanism, is utilized for mounting the replaceable tip element 120 to the seat 122. In yet another non-limiting example, the replaceable tip element 120 is mechanically coupled to the seat 122 and fixed in place by welding. In any of the aforementioned coupling of the replaceable tip element 120 to the seat 122, it should be understood that the replaceable tip element 120 can be removed and replaced during routine maintenance or if an inspection deems a replacement for the replaceable tip element 120 is required. Thus, replaceable, as used with reference to the replaceable tip element 120, means that the replaceable tip element 120 is designed for easy removal and replacement during ordinary maintenance, which excludes destructive removal and replacement where two parts are not intended to be separable for the removal and replacement of one of the parts, but such removal and replacement would be possible if at least part of the part were destroyed and then repaired to effect the removal/replacement.

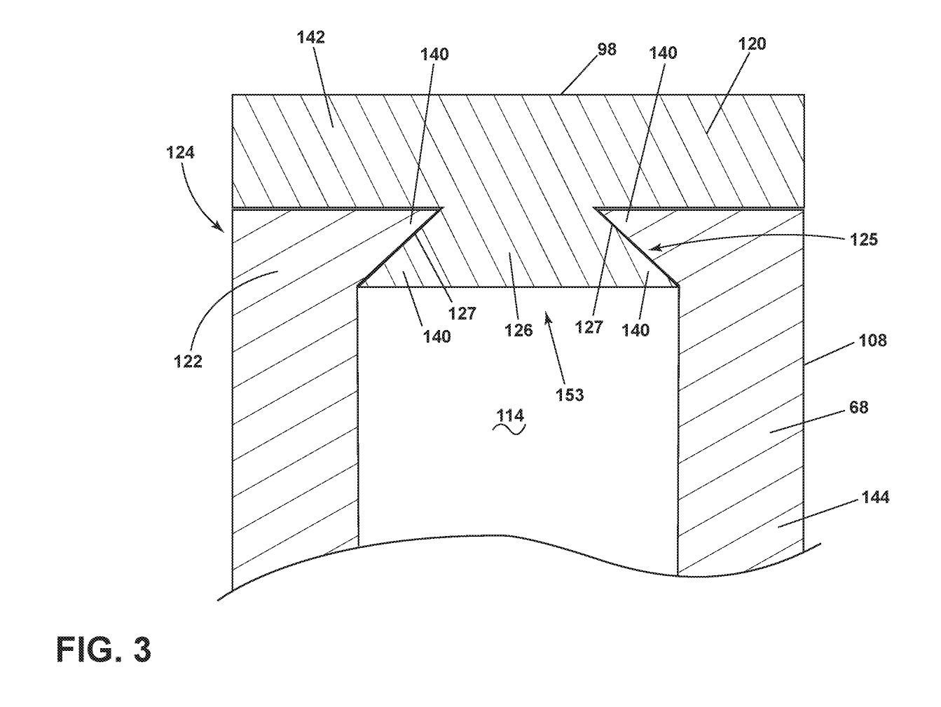

Turning to FIG. 3, a cross-section of the tip 98 and upper area 124 taken along line III-III from FIG. 2 depicts a mechanical coupling 125 with a dovetail 126 and seat 122 each having a projection 140. The dovetail 126 can include a complementary slot 127 in which the projection 140 of the seat 122 is received. It is further contemplated that the replaceable tip element 120 includes the complementary slot 127 to receive the projection 140 of the dovetail 126. The dovetail 126 encloses the interior 114 proximate the tip 98 and the seat 122. A remaining portion of the blade 68 defines the outer wall 108.

The replaceable tip element 120 can be made of any suitable tip element material 142 having a higher temperature capability than a blade material 144 used to form the seat 122 and the remaining portion of the blade 68. The temperature capability can be defined as the highest operating temperature contemplated for use for a given material in the turbine engine environment, and subjecting the material to temperatures higher than its temperature capability can cause effects such as oxidation, fatigue, or melting of the material.

The replaceable tip element 120 is a composite replaceable tip element 120 and is made of at least a portion of non-metal material, for example, but not limited to a ceramic material. In one non-limiting example, the tip element material 142 can be ceramic matrix composite (CMC) or monolithic ceramic while the blade material 144 can be metal, by way of non-limiting example a nickel based superalloy incorporating chromium, cobalt, and/or rhenium, having a lower temperature capability than the tip element material 142.

By way of non-limiting example, CMCs can include fibre and matrix materials Carbon (C), special silicon carbide (SiC), alumina (Al₂O₃) and mullite (Al₂O₃—SiO₂). Generally, CMC names are a combination of type of fibre/type of matrix. For example, C/C stands for carbon-fibre-reinforced carbon (carbon/carbon), or C/SiC for carbon-fibre-reinforced silicon carbide. Sometimes the manufacturing process is included, and a C/SiC composite manufactured with the liquid polymer infiltration (LPI) process is abbreviated as LPI-C/SiC. Commercially available CMCs are C/C, C/SiC, SiC/SiC and Al₂O₃/Al₂O₃.

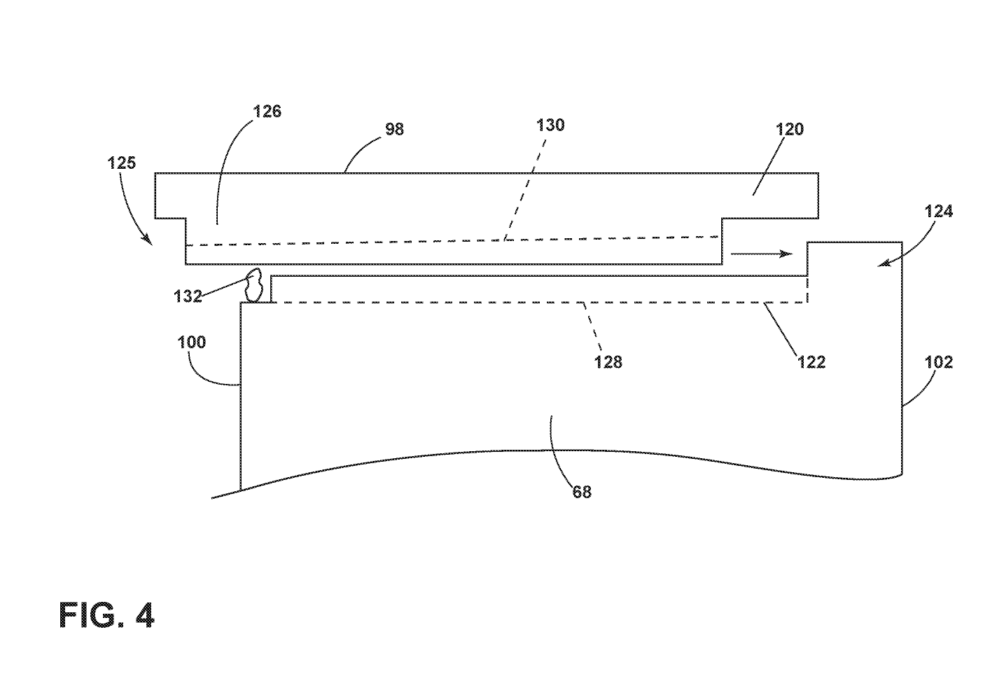

Turning to FIG. 4, a side view of the tip 98 is illustrated with the replaceable tip element 120 above the seat 122 prior to installation. The mechanical coupling 125, by way of non-limiting example a dovetail joint, mechanically couples the replaceable tip element 120 to the seat 122. The dovetail 126 of the replaceable tip element 120 is slidably received in a groove 128 located in the seat 122. The locations of the dovetail 126 and groove 128 could be swapped such that the dovetail 126 is on the seat 122 and the groove is on the replaceable tip element 120. When assembled, a retention weld 132 can be applied at the leading edge to secure the replaceable tip element 120 to the seat 122. It is also contemplated that the projection is angled as shown by the angled dashed line 130 such that when in place, the dovetail 126 is loaded aft, because the centrifugal forces will create a resultant aft force on the tip element 120 which thus protects the retention weld 132 from overload.

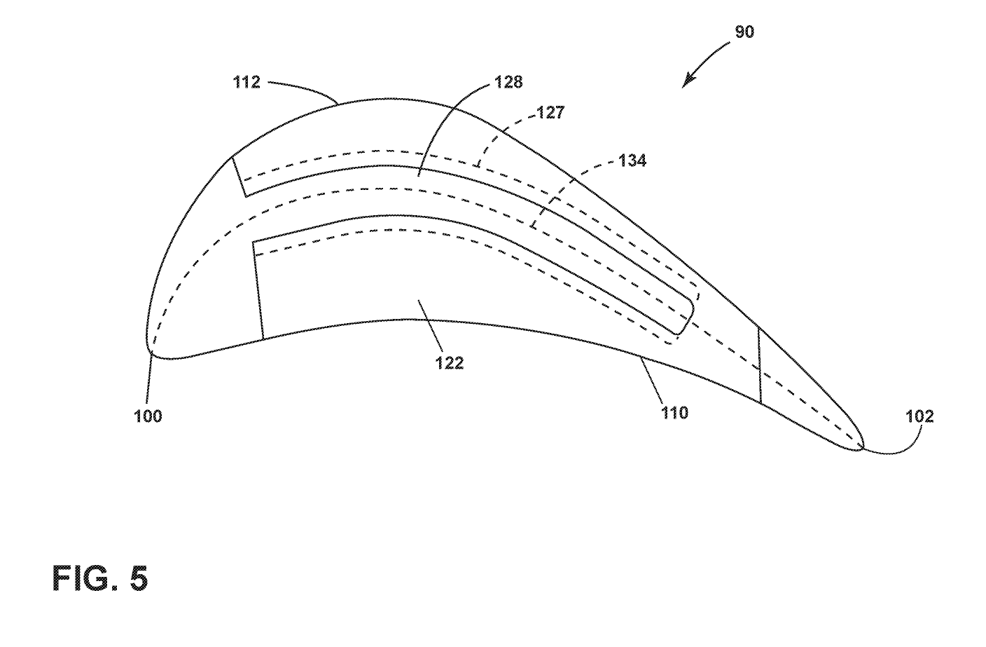

Turning to FIG. 5, a top view of the seat 122 of the airfoil 90 depicts the groove 128 extending primarily along a camber line 134 of the airfoil 90 at a constant arc. The groove 128 includes the complementary slot 127 in which the dovetail 126 can be received. In one exemplary shape the groove 128 is curved, with the option of the curve following the camber line. It is further contemplated that the groove 128 can be straight rather than curved and that the groove need not follow the camber line 134. The groove 128 is uniform in form whether curved or straight to ensure that the dovetail 126 is slidably received in the groove 128.

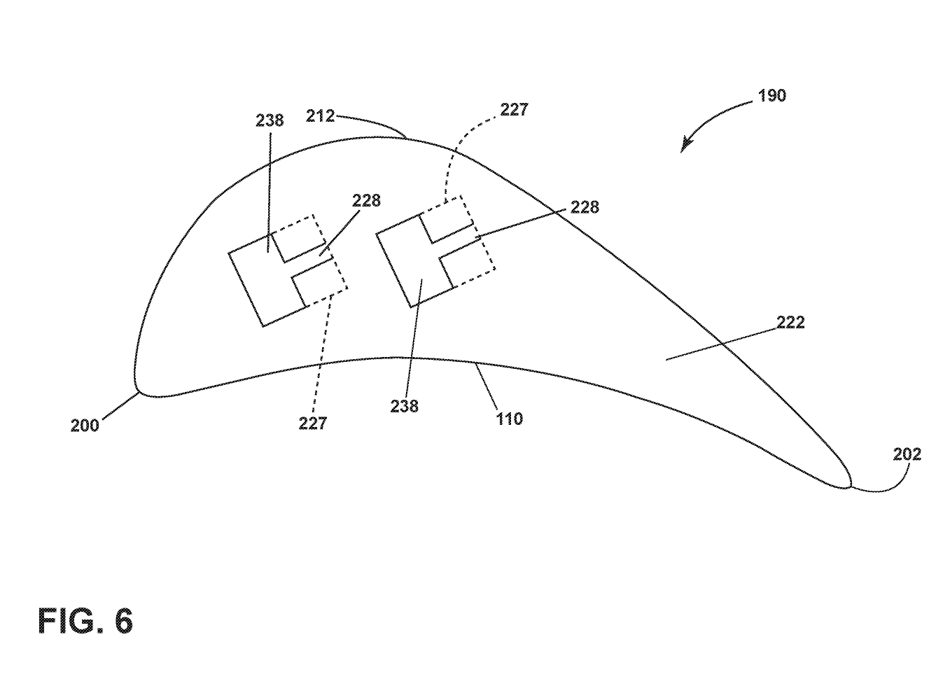

FIG. 6 illustrates a top view of a seat 222 for another exemplary airfoil 190 similar in function to the exemplary airfoil 90 illustrated in FIG. 3, therefore like parts will be identified with like numerals increased by 100. It should be understood that the description of the like parts of the exemplary airfoil 90 applies to the other exemplary airfoil 190 unless otherwise noted.

The seat 222 of airfoil 190 includes holes 238 at varying locations to receive variations of the replaceable tip element 120 described herein. A groove 228 and complementary slot 227 can extend from each hole 238 to slidably receive a replaceable tip element 220. While two holes 238 are depicted, it should be understood that more or less holes 238 are contemplated.

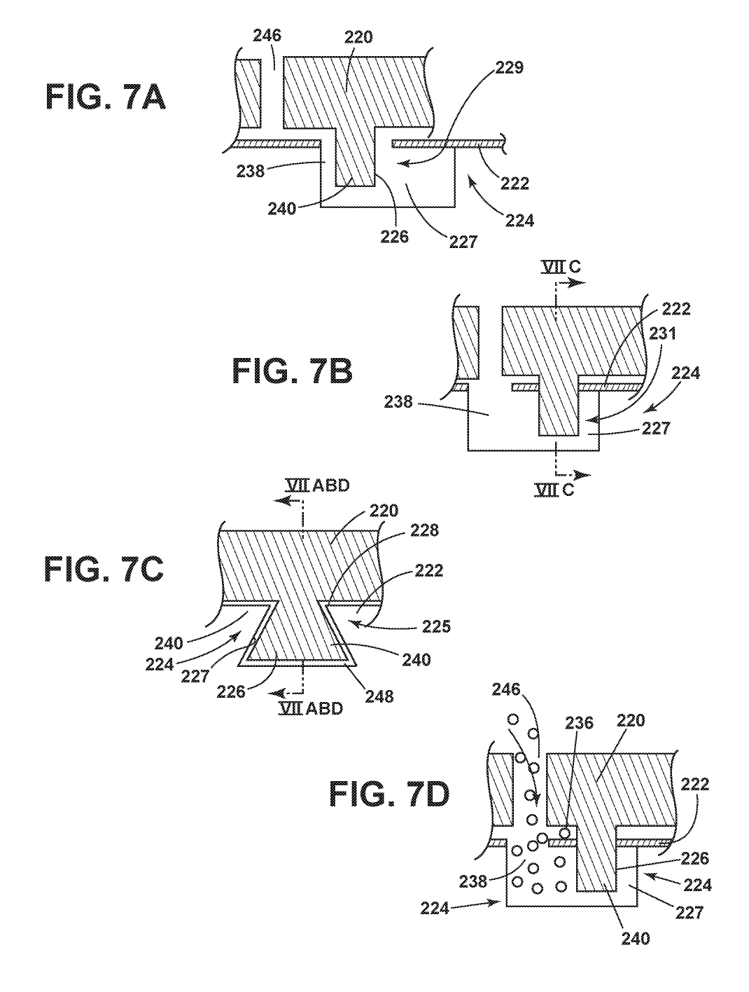

Turning to FIG. 7A, the hole 238 as viewed along a cut line VIIABD-VIIABD from FIG. 7C is shown with a replaceable tip element 220 in a first position 229. The replaceable tip element 220 can include a dovetail 226. In the first position 229, the dovetail 226 can be introduced into each of the holes 238.

In FIG. 7B, the dovetail 226 can be slid into a second position 231 such that a narrow portion of the dovetail slides along the groove 228 while a wider portion of the dovetail 226 is received in the slots 227.

FIG. 7C shows the dovetail 226 as viewed along a cut line VIIC-VIIC from FIG. 7B. This view illustrates a mechanical coupling 225, by way of non-limiting example a dovetail joint. The narrow portion of the dovetail 226 is received in the groove 228. Projections 240 of the dovetail 226 are received in complementary slots 227.

It should be understood that the dovetail 226 and hole 238 can be of any shape, for example but not limited to, trapezoidal, rounded, T-shaped, or rectangular. A gap 248 can remain between the dovetail 226 and hole 238 to allow for a purging airflow from an interior 214 of the blade 168 or to allow for errors and/or tolerances in manufacturing and to prevent hot gas from touching the metal blade.

Turning to FIG. 7D, a locking material 236, such as a braze, can be introduced through an insert hole 246 located in the replaceable tip element 220. The locking material 236 can be applied as a paste at room temperature. The locking material 236 is then heated to a high temperature to partially diffuse into the parent metal and solidifies upon cooling in order to secure the replaceable tip element 220 in the groove 228 of the seat 222.

It should be understood that the methods of joining the replaceable tip elements 120, 220 to the seats 122, 222 as described herein are exemplary and not meant to be limiting. The dovetails 126, 226 can be part of any type of tongue and groove locking joint slidably received within the seats 122, 222.

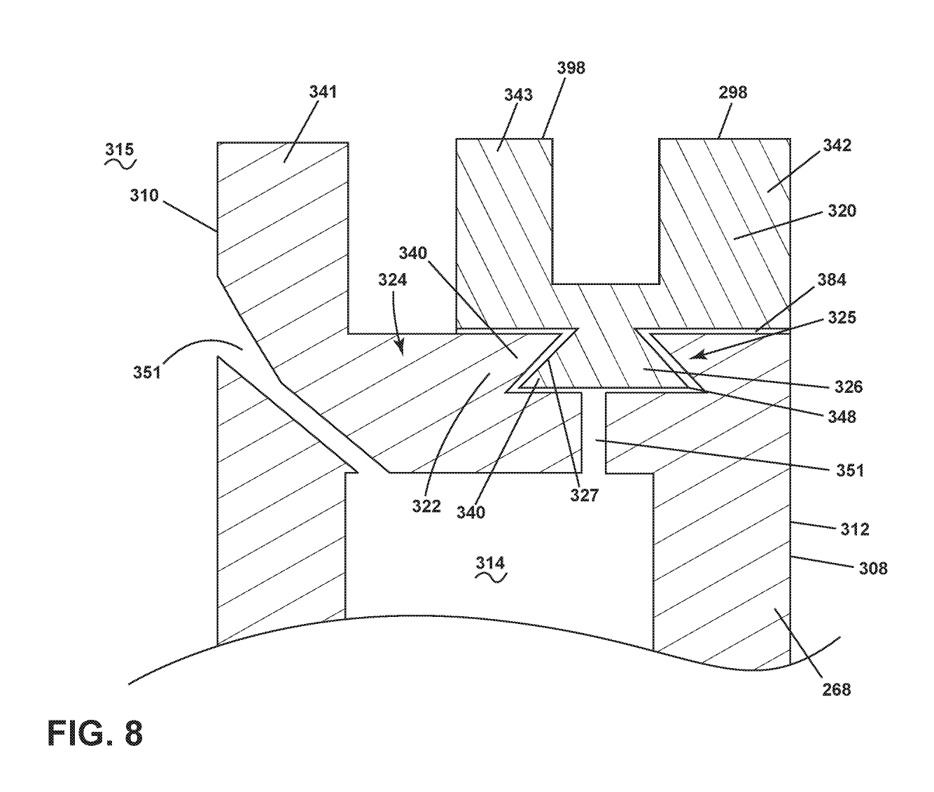

FIGS. 8-14 illustrate other exemplary replaceable tip elements 320, 420, 520, 620, 720, 820, 920 similar in function to the exemplary replaceable tip element 120 illustrated in FIG. 3, therefore like parts will be identified with like numerals increased by 200, 300, 400, 500, 600, 700, 800 respectively. It should be understood that the description of the like parts of the exemplary replaceable tip element 120 applies to the other exemplary replaceable tip elements 320, 420, 520, 620, 720, 820, 920 unless otherwise noted.

In FIG. 8, the replaceable tip element 320 forms part of a suction side 312 at a tip 298 of a blade 268. The tip 298 terminates in a peripheral wall 341, a portion of which is formed by the replaceable tip element 320. The replaceable tip element 320 can further include a tip baffle 343 located interiorly of the peripheral wall 341. The blade 268 can include shaped cooling holes 351 fluidly coupling an interior 314 of the blade 268 to an exterior 315 of the blade 268 on a pressure side 310. It is further contemplated that cooling holes 351 can extend from the interior 314 to a gap 348 proximate the replaceable tip element 220.

The cooling holes 351 can be part of one or more interior cooling circuits for routing the cooling air through the blade 268 to cool different portions of the blade 268. In particular the cooling holes 351 are dedicated to cooling the pressure side 310 and the gap 348. It is further contemplated that the gap 348 is additionally provided to account for a factor of safety in manufacturing of both the replaceable tip element 320 and the seat 322. The replaceable tip element 320 can be slidably mounted to the seat 322 in any of the methods previously described herein.

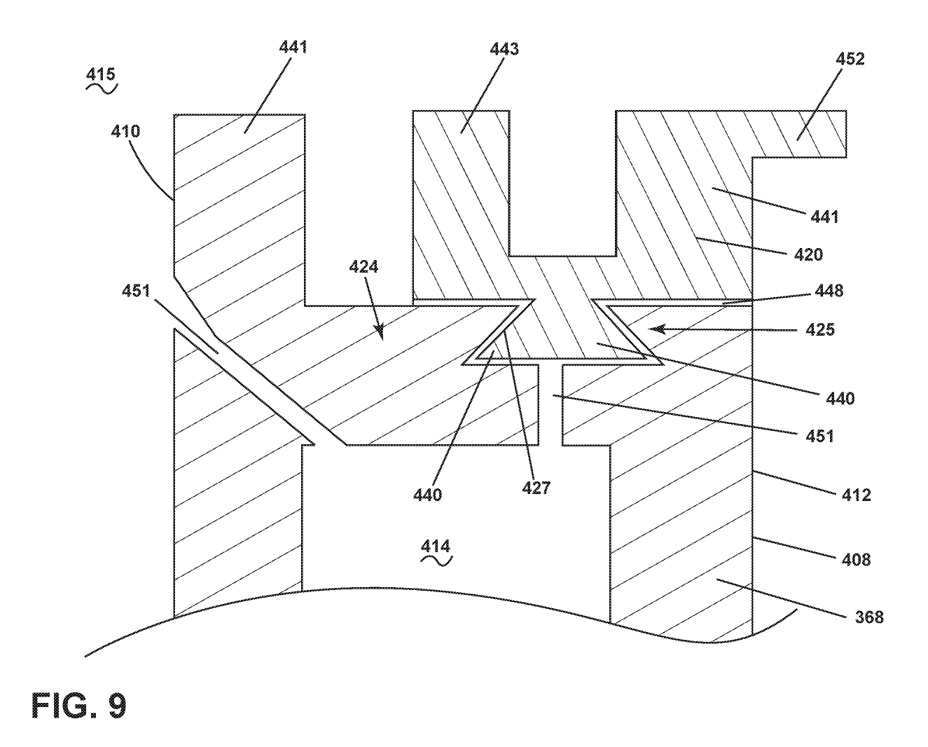

FIG. 9 depicts an exemplary replaceable tip element 420 similar to the exemplary replaceable tip element 320. The exemplary replaceable tip element 420, includes a discourager 452 on a suction side 412 at a tip 398 of a blade 368. The discourager reduces leakage over the tip 398 and manages secondary flows which can help overall airfoil performance. The replaceable tip element 320 can be slidably mounted to the seat 322 in any of the methods previously described herein.

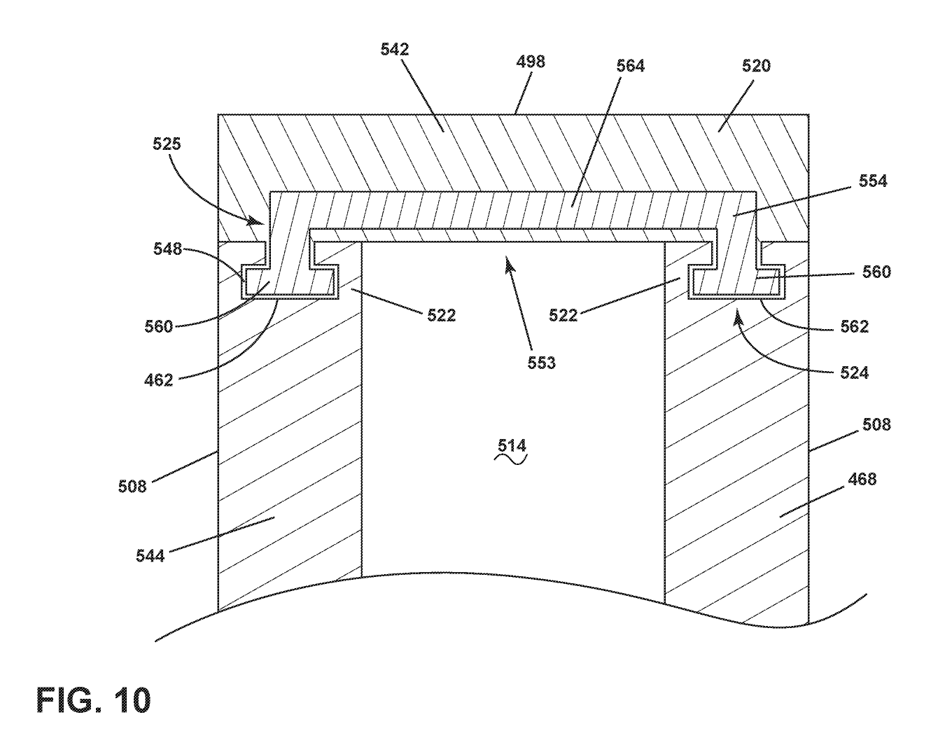

FIG. 10 illustrates another exemplary replaceable tip element 520 with an alternative mechanical coupling 525 at an upper area 524 of a blade 468. The replaceable tip element 520 encloses an interior 514 of the blade 468 at an open tip 553. The replaceable tip element 520 is a composite of a tip element material 542, in a non-limiting example CMC, and a metal alloy 554. The metal alloy 554 can be formed from, but is not limited to, a material similar in composition to the blade material 544 out of which the blade 468 is formed.

A set of T-rails 560 formed from the metal alloy 554 extends out from the replaceable tip element 520 proximate opposing outer walls 508 of the blade 468. The upper area 524 of the blade 468 defines a seat 522 having a track 562 formed to receive the T-rails 560 such that the replaceable tip element 520 is mounted to the seat 522. A gap 548 between the track 562 and the T-rails 560 permits error and/or tolerances in manufacturing the T-rails 560 and receiving tracks 562. It is further contemplated that the gap 548 can enable a purging airflow from the interior 514 of the blade 468.

The replaceable tip element 520 can be co-cast with the metal alloy 554 pre-manufactured and provided within the tip element material 542. The metal alloy 554 is manufactured in part as a bridge 564 in the spanning a width of the blade 568. The bridge 564 can have a large surface area within the replaceable tip element 520 such that the centrifugal loading can be distributed to minimize stresses in the tip element 520.

The replaceable tip element 520 can be slidably mounted to the seat 522. The tracks 562 can be side-by-side grooves extending in a chord-wise direction in a similar geometry to the seat 122 depicted in FIG. 5. It is also contemplated that the tracks 562 can be multiple holes having slots and grooves for receiving the tracks 562 similar to the seat 222 depicted in FIG. 6.

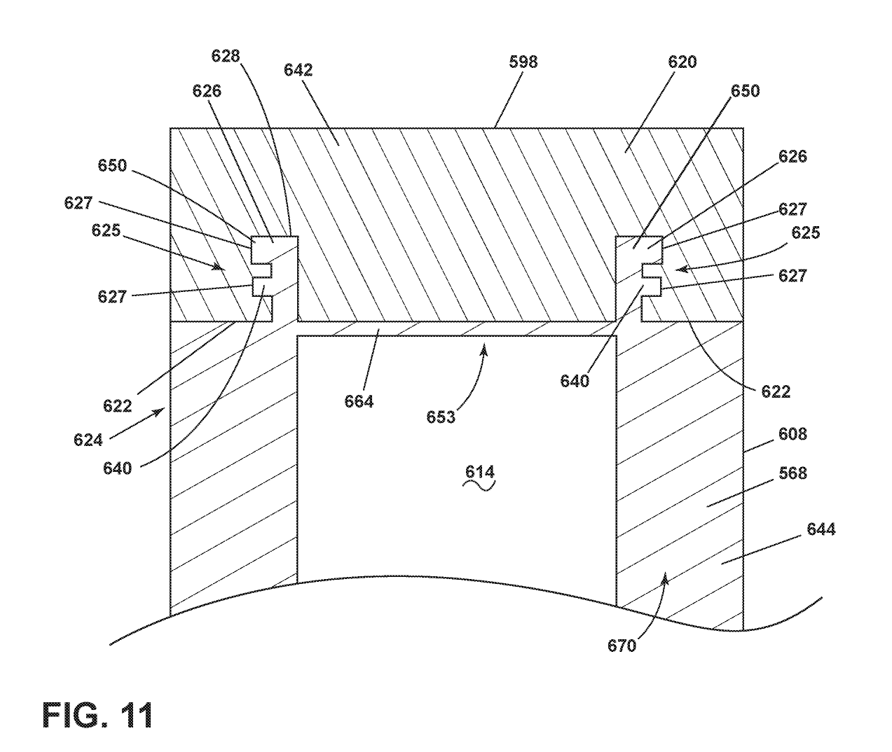

FIG. 11 is a fifth exemplary replaceable tip element 620 and blade 568. A mechanical coupling 625 connects a seat 622 of the blade 568 to the replaceable tip element 620. A collar 650 extending from the seat 622 of the blade 568 is shaped to be received within slots 627 and grooves 628. A bridge 664 connects opposing walls 608 of the blade 568. The bridge 664 separates the replaceable tip element 620 from an interior 614 of the blade 568. The replaceable tip element 620 is made of a tip element material 642, in a non-limiting example CMC, and the blade 568 is made of a blade material 644, preferably a metal superalloy.

To form the blade 568, a typical injection molding process can occur where a metal base portion 670 can be cast with the replaceable tip element 620 formed from a tip element material 642, for example but not limited to a non-metal material such as CMC. The casting process can include manufacturing the replaceable tip element 620 and a conventional internal core portion (not shown) having the same shape and size as the interior 614 of the blade 568. After assembling the replaceable tip element 620 and the internal core portion for the blade 568 a wax injection formed shell can be used to form the blade 568. After forming a mold for the blade 568, the wax can be removed and a blade material 644 in the form of a molten metal alloy can be poured into the mold. Upon completion, the internal core portion can be leached out such that the replaceable tip element 620 and base portion 670 are left as illustrated forming a complete blade 568.

The replaceable tip element 620 is manufactured with the slots 627 and grooves 628 formed to receive the blade material 644 during the co-cast process that hardens to form the collar 650. It is contemplated that the collar 650 can extend chord-wise along the entirety of the blade 568 mirroring the shape of the blade 568. It is further contemplated that the collar 650 is intermittent protrusions rather than a continuous line. The intermittent protrusions can be symmetrical or random or any combination suitable for connecting the replaceable tip element 620 to the blade 568.

It is further contemplated that the base portion 670 is provided from an existing blade 568 wherein a damaged portion of the tip (not shown) is severed from the blade 668 to form the seat 622. The mechanical coupling 625 as described herein can be formed to receive the replaceable tip element 620 onto the existing blade 568.

It should be understood that the replaceable tip elements 120, 320, 420, 520 described herein can also be manufactured and co-cast as described herein. Likewise the replaceable tip element 620 can be slidably received on the seat 622.

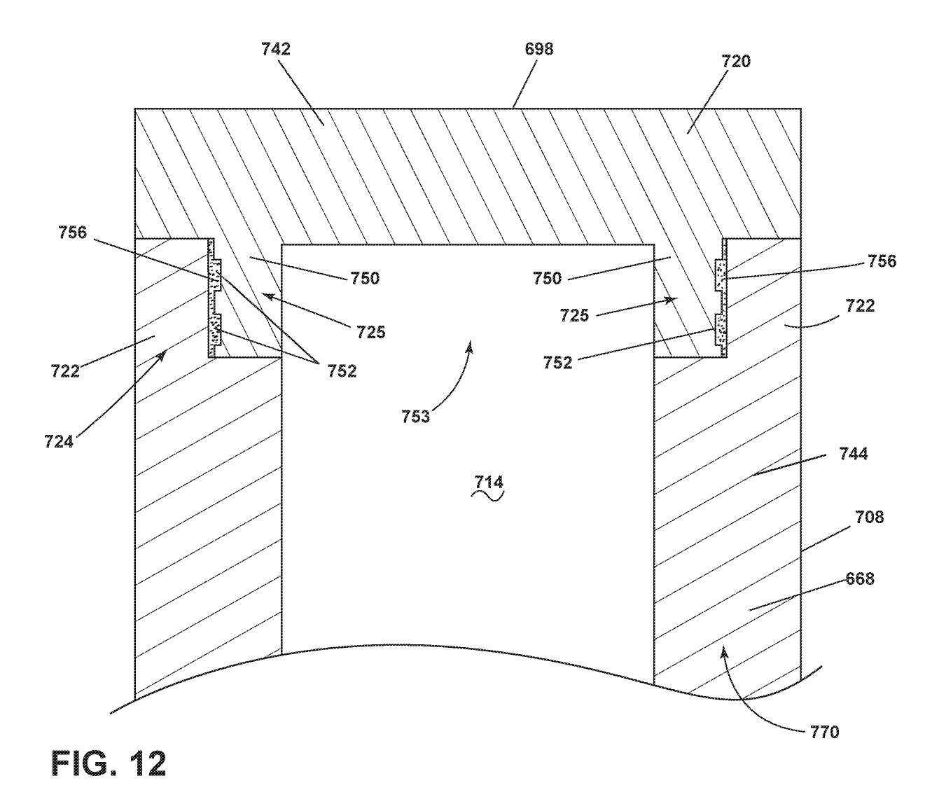

FIG. 12 is a sixth exemplary replaceable tip element 720 with a mechanical coupling 725 having a collar 750 extending from the replaceable tip element 720. The collar 750 can define slots 752. The replaceable tip element 720 is made of a tip element material 742, in a non-limiting example CMC, and the blade 668 is made of a blade material 744, preferably a metal alloy. A bonding agent 756 can be provided in the slots 752 to adhere the replaceable tip element 720 to a seat 722 in the upper area 724 of a blade 768.

The bonding agent 756 is an adhesive with a braze-like material having high-strength, high temperature qualities capable of bonding, such as braze, the replaceable tip element material 742 to the blade material 744. In one non-limiting example, the collar 750 can be bonded to the seat 722 such that the replaceable tip element 720 encloses an open tip 753 of the blade 668.

A method of manufacturing the blade 668 can include casting a base portion 770 having an open tip 753 and enclosing the open tip 753 with a pre-manufactured replaceable tip element 720. Enclosing the open tip 753 can include welding or brazing the replaceable tip element 720 to a seat 722 at an upper area 724 of the blade 668. This method enables an inspection of the interior 714 of the blade 668. The inspection can occur after casting the base portion 770. It is further contemplated that an inspection before replacing a replaceable tip element 720 can occur.

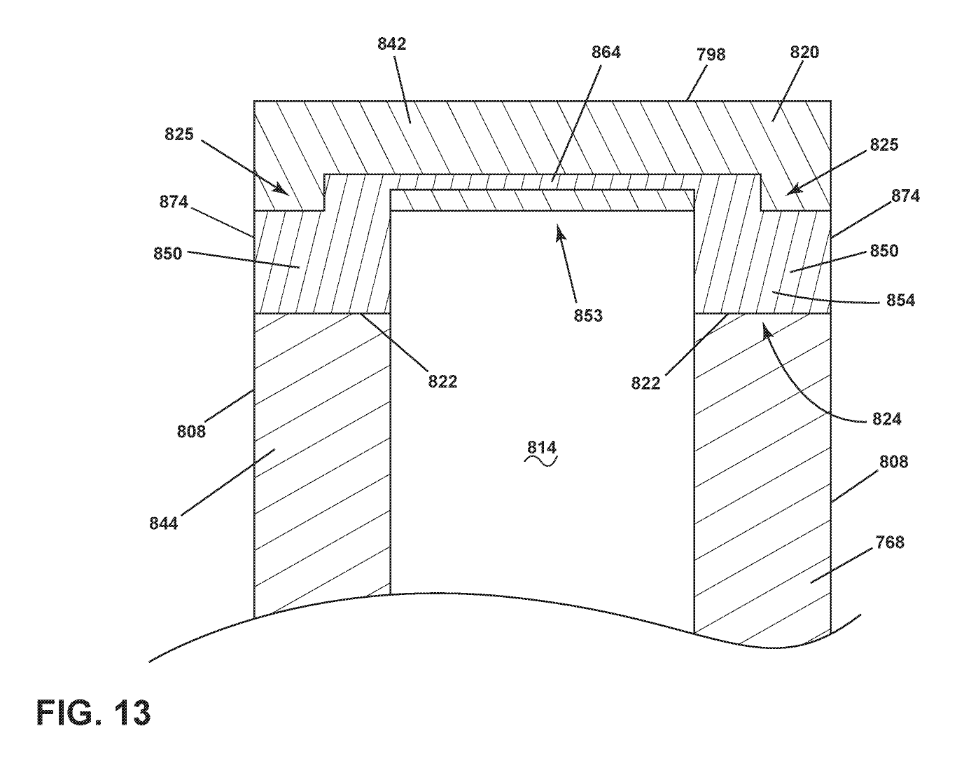

A seventh replaceable tip element 820 of FIG. 13 includes a bridge 864 located within the replaceable tip element 820. Extending from the bridge 864 and out of the replaceable tip element 820 is a collar 850 defining opposing walls 874. An upper area 824 of a blade 768 terminates in a seat 822. The seat defines outer walls 808 of the blade 768. The collar 850 has the same dimensional width as the outer walls 708. The collar 850 can therefore be mounted to the seat 822 such that the opposing walls 874 are flush with the outer walls 808.

The replaceable tip element 820 is formed from a tip element material 842, by way of non-limiting example a CMC. The blade 768 is formed from a blade material 844, by way of non-limiting example a metal alloy having a temperature capability that is less than or equal to the tip element material 842. The bridge 864 and collar 850 are formed from a metal alloy 854 having a temperature capability greater than or equal to the blade material 844. The bridge enables the replaceable tip element 820 and the collar 850 to be co-cast. In one non-limiting example, the collar 850 can be welded to the seat 822 such that the replaceable tip element 820 encloses an open tip 853 of the blade 768.

A method of manufacturing the blade 768 is similar to the methods in which the replaceable tip element 820 is welded to the upper area 824 of a blade as already discussed herein. The method can further include manufacturing the tip element 820 by co-casting the bridge 864 and collar 850 with the replaceable tip element material 842.

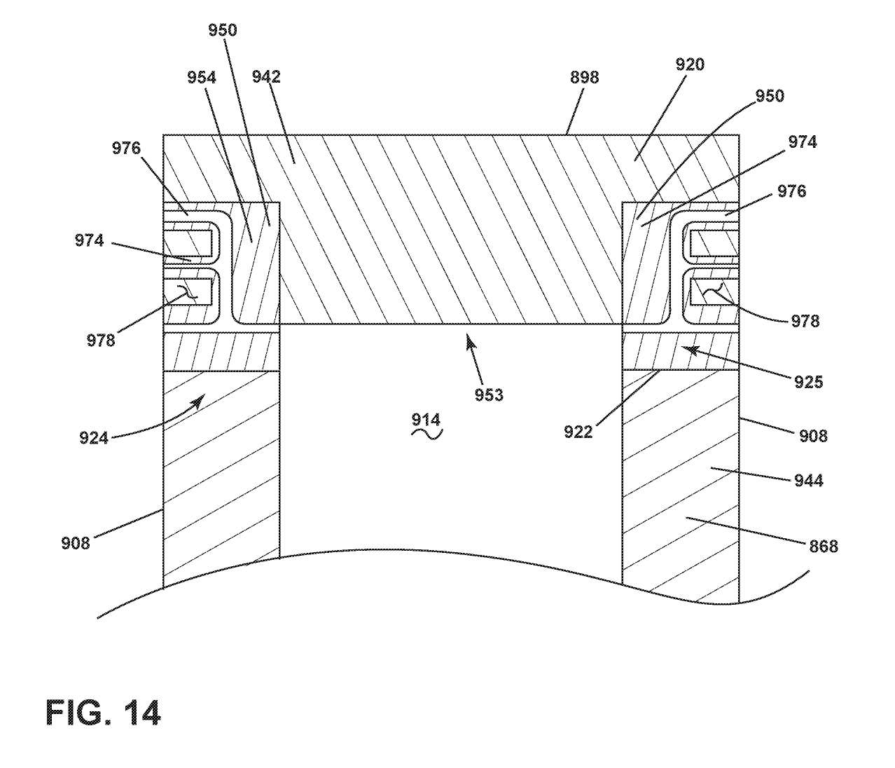

In an eighth exemplary replaceable tip element 920 illustrated in FIG. 14, the replaceable tip element 920 is formed from a tip element material 942, by way of non-limiting example a CMC, and a metal alloy 954. A collar 950 extends from the replaceable tip element 920 to define opposing walls 974. Cooling channels 976 extend throughout an interior 978 of the collar 950. The cooling channels 976 enable cooling of a metal alloy 954 from which the opposing walls 974 are made.

The replaceable tip element 920 is formed from a tip element material 942, by way of non-limiting example a CMC. The blade 868 is formed from a blade material 944, by way of non-limiting example a metal alloy having a temperature capability that is less than or equal to the tip element material 942. The collar 950 is formed from a metal alloy having a temperature capability that is greater than or equal to the blade material 944. The cooling channels 976 enable the replaceable tip element 920 and the collar 950 to be co-fabricated during the ceramic manufacturing process. The cooling channels 976 can have a dual use and be used during co-fabrication and also during engine operation for cooling. Similar to the sixth mechanical coupling 825, the collar 950 can be secured to a seat 922 by welding or other suitable metal to metal method of securing.

A method of manufacturing the blade 868 is similar to the methods in which the replaceable tip element 920 is welded to a base portion 970 as already discussed herein. The method can further include forming the cooling channels 976 in the collar 950 when fabricating the replaceable tip portion 920.

A method of manufacturing the blades described herein can include any combination of the following methods. While numerals associated with the first exemplary blade 68 are used, it should be understood that the numerals can include any or all of the exemplary blades 68, 168, 268, 368, 468, 568, 668, 768, 868 described herein.

The method can include casting a metal base portion with the replaceable tip element 120 formed from some non-metal material, for example but not limited to CMC. In some examples described herein casting the upper area 124 of the blade 68 to the replaceable tip element 120 includes co-casting an internal core portion made of a ceramic material, used to form the interior 114, with the replaceable tip element 120. After co-casting, the blade 68 is formed by molding around the co-cast internal core portion and the replaceable tip element 120. The molding can include injecting a mold with a removable material, for example but not limited to a wax, after which the mold is dewaxed. Molten metal alloy is poured to form the remaining portion of the blade 68. The internal core portion can be leached out to form the interior 114 upon completion. The co-casting can include separating the internal core portion from the replaceable tip element 120 with a metal barrier as is depicted in FIG. 11. It is contemplated that the ceramic material utilized to form the interior is leachable material. The ceramic material used at least in part to form the replaceable tip element 120 is not leachable with a temperature capability higher than the metal from which the remaining portion of the blade 68 is formed.

It is further contemplated that the base portion 124 is provided from an existing blade 68 wherein a damaged portion of the tip (not shown) is severed from the blade 68 to form the seat 122. The replaceable tip element 120 can be welded to the base portion 124 of the existing blade 68 as described herein.

Another method of manufacturing the blade 68 can include casting the base portion 124, described herein as the upper area 124 of the blade 68 having an open tip 153 and enclosing the open tip 153 with a replaceable tip element 120. The molding can further include co-casting the replaceable tip element 120 with metal extensions, for example the T-rails 560 of FIG. 10, to form a composite tip element 120. In a further example, the co-casting can include forming the cooling channels 976 as illustrated in FIG. 14. Enclosing the open tip 153 can include welding, or sliding the replaceable tip element 120 to the seat 122 of the upper area 124 of the blade 68.

It is further contemplated that the base portion 124 is provided from an existing blade 68 wherein a damaged portion of the tip (not shown) is severed from the blade 68 to form the seat 122. The mechanical coupling 125 as described herein can be formed to receive the replaceable tip element 120 onto the existing blade 68.

It should be understood that any combination of the methods in relationship to developing the replaceable tip element 120 and mounting the replaceable tip element to the seat 122 described herein are contemplated. It is also contemplated that the methods can be applied in part or in whole to develop or form any exemplary airfoil 90 described herein. The airfoils referred to in the methods described are for example only and not meant to be limiting.

This invention is a method for integrating a CMC or ceramic tip into a cast turbine blade by engineering the geometries and managing the thermal stresses during manufacturing and operation.

The replaceable tip element described herein allows for replacing coatings and/or film cooling required at the tip of a blade with a replaceable tip element made from a monolithic ceramic or CMC material capable of withstanding higher temperatures in the engine during operation. Additionally the ceramic or CMC material is less dense than typical metal super alloys which reduces overall blade weight and stresses. Three ways of mounting the replaceable tip element to the blade include manufacturing separate pieces and mechanically joining them together via a dovetail, co-casting the replaceable tip element and the blade, and finally co-casting the replaceable tip element and then welding/joining it to the metal blade tip.

Regardless of the method of joining the replaceable tip element to the blade, the replaceable tip element enables higher temperature blade tips and better rub combination between the blade tip and a ceramic or CMC shroud. This makes for a more durable blade tip with little to no film cooling required. The higher temperature capabilities also increase the temperatures for operation resulting in an overall better specific fuel consumption for the gas turbine engine. The replaceable tip element is also more conducive to repairs and replacement during routine engine maintenance and overhauls.

It should be appreciated that while the description is directed toward an airfoil, the concepts as described herein can have equal applicability in additional engine components, such as a vane, shroud, or combustion liner in non-limiting examples, and flow enhancers within the passage of the airfoil can be any similar region of any engine component having a tip or thin edge element.

It should be appreciated that application of the disclosed design is not limited to turbine engines with fan and booster sections, but is applicable to turbojets and turbo engines as well, or any other engine requiring fluid cooling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
an outer wall defining an interior and including a pressure side and a suction side extending axially between a leading edge and a trailing edge defining a chord-wise direction and extending radially between a root and a tip defining a span-wise direction, with the tip having a replaceable tip element having a different temperature capability than a remaining portion of the airfoil.

2. The airfoil of claim 1 wherein the tip further comprises a seat and the replaceable tip element is mounted to the seat.

3. The airfoil of claim 2 wherein the tip further comprises a mechanical coupling connecting the replaceable tip to the seat.

4. The airfoil of claim 3 wherein the mechanical coupling comprises a dovetail with a projection on one of the replaceable tip and seat and a complementary slot, receiving the projection, on the other of the replaceable tip and seat.

5. The airfoil of claim 1 wherein the replaceable tip element is made from different material than the seat.

6. The airfoil of claim 5 wherein the replaceable tip element is made of a material with a higher temperature capability than the seat.

7. The airfoil of claim 5 wherein the replaceable tip element is made from ceramic and the seat is made of metal.

8. The airfoil of claim 7 wherein the ceramic is a ceramic matrix composite.

9. The airfoil of claim 1 wherein the tip terminates in a peripheral wall and the replaceable tip element forms a portion of the peripheral wall.

10. The airfoil of claim 9 wherein the replaceable tip element further comprises a tip baffle located interiorly of the peripheral wall.

11. An engine component for a turbine engine, the engine component comprising:
an outer wall defining an interior and including a pressure side and a suction side extending axially between a leading edge and a trailing edge defining a chord-wise direction and extending radially between a root and a tip defining a span-wise direction, with the tip having a replaceable tip element having a different temperature capability than a remaining portion of the engine component.

12. The engine component of claim 11 wherein the tip further comprises a seat and the replaceable tip element is mounted to the seat.

13. The engine component of claim 12 wherein the tip further comprises a mechanical coupling connecting the replaceable tip to the seat.

14. The engine component of claim 13 wherein the mechanical coupling comprises a dovetail with a projection on one of the replaceable tip and seat and a complementary slot, receiving the projection, on the other of the replaceable tip and seat.

15. The engine component of claim 11 wherein the replaceable tip element is made from different material than the seat.

16. The engine component of claim 15 wherein the replaceable tip element is made of a material with a higher temperature capability than the seat.

17. The engine component of claim 15 wherein the replaceable tip element is made from ceramic and the seat is made of metal.

18. The engine component of claim 17 wherein the ceramic is a ceramic matrix composite.

19. The engine component of claim 11 wherein the tip terminates in a peripheral wall and the replaceable tip element forms a portion of the peripheral wall.

20. The engine component of claim 19 wherein the replaceable tip element further comprises a tip baffle located interiorly of the peripheral wall.

21. A method of manufacturing an airfoil extending between a leading edge and a trailing edge to define a chord-wise direction and extending between a root and a tip to define a span-wise direction, the method comprising casting a metal base portion with a replaceable tip element having a non-metal portion.

22. The method of claim 21 wherein the casting a metal base portion with a replaceable tip element further includes co-casting an internal core portion made of a ceramic material with the replaceable tip element.

23. The method of claim 22 wherein the casting a metal base portion with a replaceable tip element further includes molding around the co-cast internal core portion and replaceable tip element.

24. The method of claim 22 wherein the co-casting includes separating the internal core portion from the replaceable tip element with a metal barrier.

25. The method of claim 22 wherein the casting includes leaching out the internal core portion.

26. The method of claim 21 wherein the casting a metal base with a replaceable tip element further includes injecting a mold with a removable material.

27. The method of claim 26 wherein the casting a metal base with a replaceable tip element further includes dewaxing the mold.

28. A method of forming an airfoil extending between a leading edge and a trailing edge to define a chord-wise direction and extending between a root and a tip to define a span-wise direction, the method comprising:
providing a base portion with an open tip; and
enclosing the open tip with a replaceable composite tip element.

29. The method of claim 28 wherein the providing further includes casting a base portion with an open tip.

30. The method of claim 29 wherein casting the base portion includes inspecting an interior of the base portion.

31. The method of claim 29 wherein the casting further includes co-casting the replaceable composite tip element of the airfoil with metal extensions.

32. The method of claim 31 wherein the co-casting includes forming cooling channels in the metal extensions.

33. The method of claim 32 wherein the enclosing the open tip includes welding the replaceable composite tip element to the base portion.

34. The method of claim 28 wherein the providing further includes severing a damaged tip portion from an existing airfoil to form a seat.

35. The method of claim 34 wherein the enclosing the open tip includes forming a mechanical coupling on the seat to receive the replaceable tip element.

36. The method of claim 34 wherein the enclosing the open tip includes welding the composite replaceable tip element to the seat.

37. The method of claim 28 wherein the enclosing the open tip includes sliding the replaceable composite tip element onto the base portion.

38. The method of claim 37 wherein the sliding includes receiving a portion of the replaceable composite tip element in a hole provided in the base portion.

39. The method of claim 37 wherein the sliding includes locking the replaceable tip element to the base portion.
